(19) United States
(12) Patent Application Publication
(10) Pub. No.: US 2007/0253532 A1
(43) Pub. Date: Nov. 1, 2007

(54) Coherent Scatter Imaging

(75) Inventors: Udo Van Stevendaal, Ahrensburg (DE); Jens-Peter Schlomka, Hamburg (DE); Michael Grass, Buchholz In Der Nordheide (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,741

(22) PCT Filed: Sep. 9, 2005
(86) PCT No.: PCT/IB05/52952

§ 371 Date: Mar. 6, 2007

(30) Foreign Application Priority Data
Sep. 11, 2004 (GB) 0420224.8

(51) Int. Cl. G01N 23/201

(52) U.S. Cl. 378/87

(57) ABSTRACT

A CSI system is described that uses pencil beams 40,42,44,46 through a sample 30 having a region of interest 32. Each coherent scatter spectrum of sample beams 40, 44 through the region of interest is subtracted by the spectra using respective reference beams 42, 46. The measurements are combined to determine features of the region of interest 32 whilst minimising the effect of features in the rest of the sample 30.

The invention relates to an apparatus and method for coherent scatter imaging.

There is an ongoing need for fast and reliable materials scanners. One area of particular commercial interest is that of fast baggage scanners that can be used in a number of instances, but are often particularly used to scan airline baggage. Another area of particular commercial interest is in the field of medical scanners.

The interaction of X-ray photons with matter in a certain energy range between 20 and 150 keV, for instance, can be described by photoelectric absorption and scattering. Two different types of scattering exist: incoherent or Compton-scattering on the one hand, and coherent or Rayleigh-scattering on the other hand. Whereas the Compton-scattering varies slowly with angle, Rayleigh-scattering is strongly forward directed and has a distinct structure, characteristic of each type of material. Coherent X-ray scattering is a common tool for analyzing the molecular structure of materials in e.g. X-ray crystallography or X-ray diffraction in the semiconductor industry. The molecular structure function is a fingerprint of the material and allows good discrimination. For example, plastic explosives can be distinguished from harmless food products.

For medical use as well as for baggage inspection, photoelectric absorption, not scattering, is generally used in commercial computed tomography (CT) scanners and C-arm systems. These systems use a variety of calculation techniques to calculate from measured X-ray data the X-ray absorption properties of the sample at different locations in the sample, rather than simply provide an X-ray image of the sample as in conventional X-ray imaging.

For example, US2002/0150202A1 describes a CT apparatus using a fan beam and describing also a gantry rotating the apparatus.

In modern equipment, a cone-shaped X-ray beam is often used, in so called “cone-beam” computed tomography. US2004/0076265 describes a CT scanner of this type.

Since material discrimination is limited to differences in the total linear attenuation coefficient, this method can only provide good discrimination if the linear attenuation coefficients of the regions of interest differ perceptibly. Furthermore, tissue or material identification using only the linear attenuation coefficient can be ambiguous, if two different materials exhibit the same attenuation coefficient.

Since scattered photons contain additional object information, they can be used for a better material discrimination.

U.S. Pat. No. 5,692,029 describes a detector that uses backscattered X-rays for a is baggage handling application.

Coherent scattering has been presented as a suitable means for baggage scanning in Strecker et al “Detection of Explosives in Airport Baggage using Coherent X-ray Scatter”, SPIE Volume 2092 “Substance Detection Systems”, 1993, pages 399 to 410. This document describes the different elastic scattering spectra of explosives and a number of other common materials.

Although no actual measurements are described of baggage samples, this document suggests that in order to meet speed requirements imaging is not feasible, and instead the energy spectrum, presumably of the whole baggage, is measured. Thus, the proposed system is unsuitable for detailed scanning of particular items within baggage.

Other X-ray scattering experiments are described in “X-ray scattering signatures for material identification”, Speller et al, in the same volume, SPIE Volume 2092 “Substance Detection Systems”, 1993, at pages 366 to 377.

In spite of interest over a number of years baggage scanners using coherent scattering have not, to date, moved out of the research lab into operational use. This is for a number of reasons, including a low signal strength inherent in coherent scattering and practical implementation difficulties.

Instead, baggage scanners in practice simply measure the absorption of X-rays, generally using conventional imaging. Such systems, however, do not provide good discrimination and it may be very hard to tell if a particular absorption feature is caused by explosive or any of a number of common materials, for example chocolate, plastics, or many others.

Similar problems arise in identifying features in medical CT scans.

Accordingly, there is a need for an improved coherent scatter imaging method and apparatus that can assist in these regards.

According to the invention there is provided a Coherent-Scatter imaging system according to claim 1.

By focussing on a region of interest, and correcting the sample spectrum measured with the sample beam for absorption effects using the spectrum of a parallel reference beam, many features of the spectrum caused by regions other than the region of interest can be removed from the measured spectrum. This makes subsequent analysis easier.

Preferably, a number of additional sample paths are used. For each additional path, the method then includes passing a pencil X-ray beam through the sample along the additional sample path and measuring an additional sample scatter spectrum; passing a pencil X-ray beam through the sample along an additional reference path parallel to the additional sample path, but not passing through the region of interest and measuring an additional reference scatter spectrum; and calculating an additional difference scatter spectrum by subtracting a scatter spectrum based on the reference scatter spectrum from the sample scatter spectrum.

Then, the difference scatter spectrum and the at least one additional difference scatter spectrum may be combined to determine information about the region of interest.

This approach works since the different sample paths are not parallel to each other. The only common region passed through by the sample paths is the region of interest. Thus, in general, common features will be caused by the region of interest.

In particular, the difference spectra may be analysed to identify common features and analysing the common features as the features present in the region of interest.

In order to combine the spectra, each difference scatter spectrum may be multiplied by a respective geometric correction factor as a function of position to correct for the respective distances between source, collimator, region of interest and detector along the respective path.

In general, coherent scatter spectra cannot simply be multiplied by a geometric correction factor except for thin samples since this geometric factor would vary along the path as some regions of the sample will be closer to the detector and some closer to the source. However, in the present case only the region of interest is relevant so it is possible to simply correct the complete spectra assuming the whole measured spectrum is derived from the region of interest. In this way, features not caused by the region of interest will appear at incorrect locations. Such features are less likely to correlate with features using different paths, and accordingly in this case the use of the inaccurate approximation is actually advantageous.

The invention also relates, in another aspect, to a controller for a coherent-scatter imaging (CSI) system having a collimated X-ray source and a detector, comprising:

an interface for interfacing with the CSI system adapted to pass control signals to the CSI system and to receive image data from the detector;

and code for causing the CSI system and controller:

to carry out a scan using X-ray absorption to identify a region of interest in a sample object;

to pass a pencil X-ray beam through the sample along a sample path, passing through the region of interest, and to measure a sample scatter spectrum;

to pass a pencil X-ray beam through the sample along a reference path, parallel to the sample path, but not passing through the region of interest (32), and to measure a reference scatter spectrum;

to multiply the sample and the reference spectra by respective absorption correction coefficients to generate corrected sample and reference spectra; and

to subtract the corrected reference scatter spectrum from the sample scatter spectrum (S) to produce a difference scatter spectrum.

In a further aspect, the invention relates to a coherent-scatter imaging (CSI) system comprising:

an x-ray source;

a collimator for producing a collimated beam of X-rays from the X-ray source;

a sample chamber for holding a sample;

a multi-channel X-ray detector for detecting X-rays elastically scattered by the sample as a function of position; and

a controller as explained above.

The collimator may be moveable between a first position in which the collimator is spaced away from the beam and a second position in the X-ray beam to allow a pencil beam CSI method to be carried out.

The invention also relates to a computer program product arranged to cause a CSI scanner to carry out the method as set out above.

Specific embodiments of the invention will now be described purely by way of example, with reference to the accompanying drawings, in which:

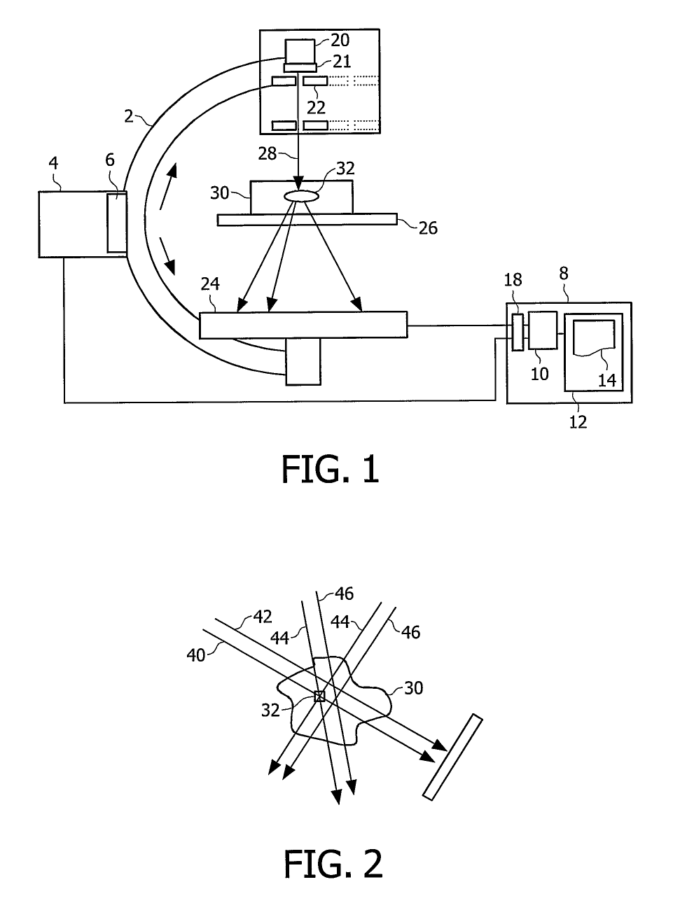

FIG. 1 shows a CSI apparatus according to an embodiment of the invention;

FIG. 2 illustrates the beam paths used in the embodiment of the invention;

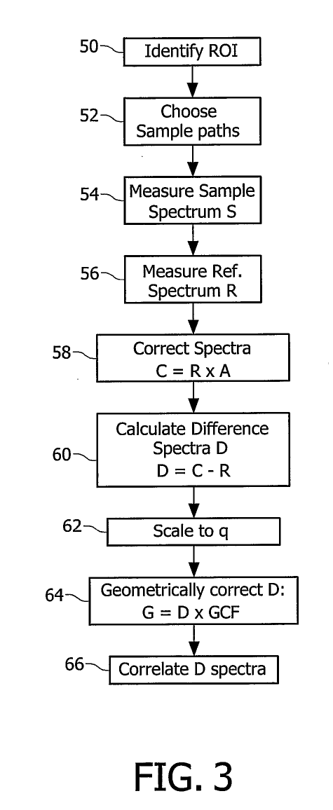

FIG. 3 is a flow diagram illustrating a method used in the embodiment of the invention; and

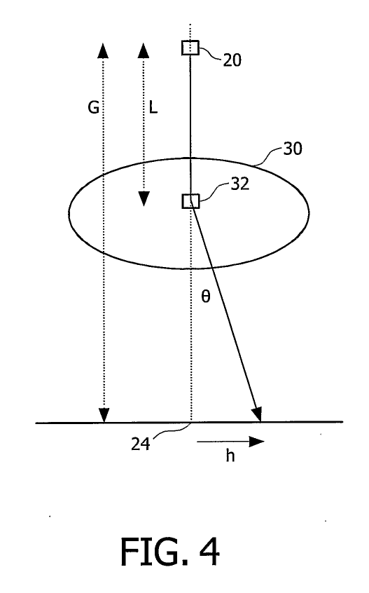

FIG. 4 is a schematic drawing showing the geometry used in the invention.

The diagrams are schematic and not to scale.

Referring to FIG. 1, CSI apparatus includes a C-arm 2 provided on mounting 4 and connected to driver 6 for driving the C-arm into any of a wide variety of positions controlled by controller 8. The C-arm supports an X-ray source 20, a collimator 22, and a detector 24. The collimator 22 can be introduced into the beam (as shown by the solid lines) or is moveable out of the beam path (as shown by the dotted lines).

The C-arm 2 can be driven by driver 6 to rotate the C-arm to orient the source 20 and detector at many different angles in three-dimensional space.

The controller 8 includes a processor 10 and memory 12, the memory 12 including code 14 for controlling the controller to cause it to drive the C-arm into selected positions as well as code adapted to cause the controller to analyse the data. The controller is connected to the C-arm system through interface 18.

A sample support 26 is provided for holding sample 30. Conveniently, in the case of a baggage handling system, the sample support may be a conveyor belt. Alternatively, the sample support 26 may be a patient support for medical applications.

The C-arm 2 is set up so that X-rays are emitted from the X-ray source 20, collimated in the collimator 22 to be directed through the sample 30, and then picked up by the detector 24 which converts the incident intensity into an electrical signal and supplies that signal to controller 8. The detector 24 is a multi-channel detector that detects X-rays as a function of position, and accordingly as a function of scatter angle.

The source 20 is preferably as monochromatic as possible to ensure as accurate a relationship as possible between the measured scattering angle and the inverse scattering wavevector q. Accordingly, optional monochromator 21 may be provided adjacent to the source 20 or elsewhere along beam 28.

In use, a sample 30 is placed on sample support 26 without the collimator in the beam path and the apparatus is used in a conventional mode without using coherent scattering information by providing X-rays from the source, illuminating the sample with the X-rays and capturing an image of the sample on the multi-channel X-ray detector 24.

The image as captured may be a conventional X-ray image. However, it is preferred to use a conventional CT detector 24 and to carry out CT processing to calculate the X-ray absorption as a function of position in the sample 30. To this end, the X-ray source and detector may be moved to multiple positions and orientations if required.

This CT calculation or X-ray image may reveal one or more suspicious regions of interest 32 in the sample.

Accordingly, the apparatus may then be used in a CSI mode as follows to provide further information about the region of interest 32, starting from the identification of the region of interest as illustrated at step 50 in FIG. 3.

In this mode, collimator 22 is introduced to provide a single pencil beam 28 of X-rays. A number of suitable sample beam paths (40,44) through the region of interest are calculated (step 52).

The different sample paths 40, 44 are selected in step 52 with a number of desiderata in mind. Firstly, the absorption of X-rays along the path should not be too large. Secondly, the paths should be in directions that are as different as possible, to illuminate the region of interest in as many different directions as possible. Thirdly, the paths should pass through regions of the sample that are as different to each other as possible, with the exception of the region of interest. It will not be possible to meet all of these criteria, so a reasonable number of paths is selected that go some way to meeting these criteria.

Firstly, the pencil beam 28 is directed along the first sample path 40 through the region of interest 32 and the sample scatter spectrum S₁ measured on the multi-channel detector 24 (step 54). Intensity is measured as a function of position across the detector, which position is related to the inverse scattering wavevector (q).

Next, the pencil beam 28 is directed along one or more first reference paths 42, parallel to the first sample path 40 but not passing through the region of interest 32, and the reference scatter spectrum R₁ measured for these one or more reference paths 42 (step 56).

The reference path or paths 42 are selected such that the absorption along the paths is roughly the same as along the sample path 40. To correct for any slight difference in the measured absorption, the reference path spectrum or spectra are absorption corrected by multiplying the spectrum by an absorption correction factor A₁ to arrive at an absorption corrected reference spectrum R_{c1}, where R_{c1}=R₁×A_{R} (step 58). The sample spectra S may also be absorption corrected: S_{c1}=S₁×Aₛ₁.

Then, the corrected scatter spectrum is subtracted from the sample scatter spectrum to obtain a first difference scatter spectrum D₁ that mainly yields information about the region of interest; D₁=S_{c1}−R_{c1} (step 60).

A second difference scatter spectrum D₂ is obtained using a different second sample path 44 through the region of interest 32 and one or more second reference paths 46 parallel to the second sample path 44 and not passing through the region of interest.

This procedure may be repeated if required one or more times, to provide a third difference scatter spectrum D₃, a fourth difference scatter spectrum D₄ and so on, using further sample paths and reference paths 44, 46.

It will be noted that the distances of the region of interest from the X-ray source and the detector are not necessarily the same in each scatter spectrum. For example, if the region of interest is close to the detector a smaller distance on the detector will correspond to a particular q value than in the case that the region of interest is far from the detector.

Accordingly, the difference spectra D are first expanded or shrunk along their respective x-axes by using the q scale for scattering from the region of interest 32. The measured spectra have as their x-axis a position coordinate.

The scattering wavevector q is given (in a small angle approximation) by:
q=h/[2 λ(G−L)].

As shown in FIG. 4, G is the distance from source to detector, L the distance from source to region of interest, and h the linear offset (x-axis) of each scatter spectrum. λ is the wavelength of the X-rays used.

In order to obtain a scatter spectrum which is quantitatively correct, the scatter spectrum is multiplied with a geometric correction factor (GCF) which is a function of position. The GCF takes into account two effects: first, that the effective detector area of the off-plane detector elements decreases with an increasing scatter angle and, second, that the solid angle of a scattered beam which reaches the detector element decreases with the distance of this element to the scatter center. The GCF for an off-plane detector element is given by: GCF=A (G−L)/(h²+(G−L)²)^{3/2}, where A denotes the detector area of one detector element.

Note that such simple multiplication by a geometric correction factor is relatively straightforward since only the scattered spectra from a small region of interest are required. Note that the correction applied will wrongly calculate the correction outside the region of interest. In the prior art a large amount of data is collected to calculate the coherent scatter spectra throughout the thickness of the sample. This requires both a large amount of data and a large amount of computing resources, since different parts of the sample will be at different distances from the detector and source and it is not be possible to simply multiply the measured spectra by a correction factor.

In contrast, the invention corrects the spectra as if they were solely based on the region of interest, in spite of the fact that this assumption is wrong. This makes the CSI approach described here much simpler than in prior approaches for samples of significant thickness, involving both less computing power and requiring less data to be collected than in prior approaches. This latter benefit is of particular advantage since it allows the total X-ray dose to be lower.

Note that since the correction will be wrong outside the region of interest the likelihood of correlation of features in the spectra outside the region of interest is reduced. Thus, in the present invention the use of an inaccurate approximation improves the ability to identify features in the region of interest.

The geometry corrected spectra now need to be combined. A first possibility to combine the spectra would be to simply average the geometry corrected spectra G.

However, the sample paths all pass through the region of interest but away from the region of interest they should pass through different regions. Accordingly, it is likely that common features of the different spectra are caused by the region of interest whereas features that appear in only one of the different spectra are not caused by the region of interest.

Accordingly, in a preferred approach, the geometry corrected spectra are correlated to identify common features to arrive at a correlated scatter spectrum related to the region of interest (step 66).

For example, a cross-correlation calculation may be performed calculated between a pair of geometry corrected spectra G to identify common features.

This correlated scatter spectrum is then used to analyse the region of interest. For example, in a baggage inspection application, the correlated scatter spectrum is compared with the spectra of a number of different types of substances, for example explosives, to see if it matches. Alternatively, in a medical application the correlated scatter spectrum is compared with the spectra of a number of different tissue types, for example to determine if the region of interest shows any pathologies.

In the event that there are multiple spectra, cross-correlation may be performed between each of the spectra and a reference scatter spectrum giving for example the expected scatter spectrum of a particular material. The average cross-correlation may then be calculated, and if the average is greater than a predetermined threshold, an alarm is given. The cross-correlation may of course be repeated for further reference spectra of all materials of interest.

By focusing on the scatter spectrum of a particular region of interest the invention allows for accurate determination of the coherent scatter spectra of a region of interest. The method only uses a number of pencil beams and accordingly the total X-ray dose used is smaller than would be required in prior systems.

The invention is particularly valuable as an add-on to a conventional CT scanner to allow CSI to be carried out on artifacts revealed by the conventional CT scanner.

Although the invention is described above using a plurality of sample beams, the invention may also be used with only one sample beam if conditions dictate.

Although the above description uses a C-arm system, the invention is also applicable to other configurations, in particular to a cone-beam CT system.

The system is not limited to baggage handling but may be used wherever X-rays may be used, for example for imaging of the human or animal body, as well as for materials evaluation.

It will therefore be apparent that there are numerous variations to the specific system described in detail, and many other modifications will be apparent to those skilled in the art.

1. A method of operating a coherent-scatter imaging (CSI) system comprising:
carrying out a scan to identify a region of interest (32) in a sample object (30);
passing a pencil X-ray beam (28) through the sample along a sample path (40), passing through the region of interest (32), and measuring a sample scatter spectrum (S₁);
passing a pencil X-ray beam through the sample (30) along a reference path (42), parallel to the sample path (40), but not passing through the region of interest (32), and measuring a reference scatter spectrum (R₁);
calculating a difference scatter spectrum (D₁) by subtracting a scatter spectrum based on the reference scatter spectrum (R₁) from the sample scatter spectrum (S₁).

2. A method according to claim 1 further comprising comparing the difference scatter spectrum (D₁) with at least one scatter spectrum M of a material of interest.

3. A method according to claim 1 further comprising:
for each of one or more additional sample paths (44) passing through the region of interest (32), the additional sample paths (44) not being parallel to the other sample paths (40,44):
passing a pencil X-ray beam (28) through the sample (30) along the additional sample path (40), passing through the region of interest (32), and measuring an additional sample scatter spectrum (S₂ ,S₃);
passing a pencil X-ray beam (28) through the sample along an additional reference path (44) parallel to the additional sample path (40), but not passing through the region of interest (32) and measuring an additional reference scatter spectrum (R₂ ,R₃);
calculating an additional difference scatter spectrum (D₂ ,D₃) by subtracting a scatter spectrum based on the reference scatter spectrum (R₂ ,R₃) from the sample scatter spectrum (S₂ ,S₃).

4. A method according to claim 3 including correlating the difference spectra (D₁ , D₂ , D₃) to identify common features and analysing the common features as the features present in the region of interest (32).

5. A controller (8) for a coherent-scatter imaging (CSI) system having a collimated X-ray source (20,22) and a detector (24), comprising:
an interface (18) for interfacing with the CSI system adapted to pass control signals to the CSI system and to receive image data from the detector;
and code (14) for causing the CSI system and controller:
to carry out a scan using X-ray absorption to identify a region of interest (32) in a sample object (30);
to pass a pencil X-ray beam (40) through the sample along a sample path, passing through the region of interest, and to measure a sample scatter scatter spectrum (S);
to pass a pencil X-ray beam through the sample along a reference path (42), parallel to the sample path (40), but not passing through the region of interest (32), and to measure a reference scatter spectrum (R);
to multiply the reference scatter spectrum (R) by a respective absorption correction coefficient (A) to generate a corrected reference scatter spectrum (C); and
to subtract the corrected reference scatter spectrum (C) from the sample scatter spectrum (S) to produce a difference scatter spectrum (D).

6. A controller (8) according to claim 5 wherein the code is additionally arranged to compare the difference scatter spectrum (D₁) with at least one scatter spectrum M of a material of interest.

7. A controller (8) according to claim 5 wherein the code (14) is arranged, for each of one or more additional sample paths (44) not parallel to the other sample paths (40,44), to cause the CSI system:
to pass a pencil X-ray beam through the sample along the additional sample path (44), passing through the region of interest (32), and to measure an additional sample scatter spectrum;
to pass a pencil X-ray beam through the sample along a reference path (46) parallel to the additional path, but not passing through the region of interest (32) and to measure an additional reference scatter spectrum;
wherein the code (14) is further arranged:
to multiply the additional reference scatter spectrum by a respective absorption correction coefficient to generate an additional absorption corrected reference scatter spectrum; and
to subtract the additional reference scatter spectrum from the additional sample scatter spectrum to produce an additional difference scatter spectrum;
to combine the difference scatter spectrum and the one or more additional difference scatter spectra to determine information about the region of interest.

8. A controller according to claim 6 further including code arranged to correlate the difference spectra to identify common features and to analyse the difference spectra based on the common features as the features present in the region of interest.

9. A coherent-scatter imaging (CSI) system comprising:
an X-ray source (20) for generating X-rays;
a collimator (22) for producing a collimated pencil beam of X-rays from the X-ray source;
a sample support (26) for holding a sample (30);
a multi-channel x-ray detector (24) for detecting x-rays elastically scattered by the sample as a function of position;
a framework (2) for supporting the X-ray source (20), collimator (22) and multi-channel x-ray detector (24);
a driver (6) for moving the framework (2); and
a controller (8) according to claim 5.

10. A CSI system according to claim 8 wherein the collimator (22) is movable between a first position away from the X-ray source (20) and a second position in line with the X-ray source (20) to produce the collimated pencil beam (28) of X-rays, the X-ray source (20) producing a wider beam of X-rays with the collimator (22) in the first position than the pencil beam (28) produced with the collimator (22) in the second position.

11. A computer program product recorded on a data carrier, the computer program product including code (14) for causing a CSI system to carry out a method according to claim 1.
